(19) United States
(12) Patent Application Publication
(10) Pub. No.: US 2006/0056397 A1
(43) Pub. Date: Mar. 16, 2006

(54) Access management apparatus, program and remote start-up method of terminal device

(75) Inventors: Hiroyuki Aizu, Yokohama-Shi (JP); Keiichi Teramoto, Kawasaki-Shi (JP); Yasuhiro Morioka, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/225,031

(22) Filed: Sep. 14, 2005

(30) Foreign Application Priority Data
Sep. 15, 2004 (JP) 2004-268274

(51) Int. Cl. H04L 12/66

(52) U.S. Cl. 370/352; 370/389

(57) ABSTRACT

There is provided with an access management apparatus which connects a communication network to a local area network and which manages access from the communication network to the local area network, the access management apparatus including: a packet receiver which receives a packet according to TCP or UDP from the communication network; a database storage unit which stores a database having a port number of the TCP or UDP in association with a MAC address; a MAC address detector which detects a MAC address associated with a destination port number in the packet received by the packet receiver, from the database; a start-up request packet generator which generates a start-up request packet to start up a terminal device having the detected MAC address on the local area network; and an output unit which outputs the generated start-up request packet to the local area network.

### CROSS-REFERENCE TO RELATED APPLICATIONS

This application claims the benefit of priority under 35USC § 119 to Japanese Patent Application No. 2004-268274, filed on Sep. 15, 2004, the entire contents of which are incorporated herein by reference.

### BACKGROUND OF THE INVENTION

1. Field of the Invention

The present invention relates to an access management apparatus and a program used to start-up a terminal device, such as a personal computer or a network electric home appliance, disposed, for example, in a house from a distant place via a communication network such as Internet, and relates to a remote start-up method of a terminal device used to start-up the terminal device from a distant place.

2. Related Art

Various methods of accessing a terminal device, such as a personal computer or a network electric home appliance, disposed in a house from a distant place via the Internet and making the terminal device execute various services have been proposed.

As a paper describing a method of setting a terminal device to a standby mode in order to hold down the power dissipation in the terminal device waiting in a house and starting up the terminal device when a Wake On signal is input, there is, for example, Japanese Patent Application Laid-Open Publication No. 2003-319083.

According to Japanese Patent Application Laid-Open Publication No. 2003-319083, an access management apparatus disposed in a house accepts specification of a name of a terminal device to be started up, from an external requesting terminal (start-up requesting terminal). The access management apparatus in the house specifies a MAC address associated with the name received from the requesting terminal, and transmits a Wake On signal to the terminal device having the MAC address. As a result, the terminal device is started up.

In this method, however, there is a procedure that an external requesting terminal specifies a terminal device to be started up to the access management apparatus in the house. Because of this procedure, work of newly adding a code to communication software using an existing protocol becomes necessary in the requesting terminal and the access management apparatus in the house.

Port forwarding setting to a home router function included in the access management apparatus in the house is conducted by using association of port numbers with IP addresses. If IP addresses of terminal devices are fixed, it takes plenty of time and labor to manage IP addresses of respective terminal devices. On the other hand, if a terminal device in a house is dynamically provided with an IP address, when the IP address is provide, the terminal device needs to notify a home router function of an IP address and the home router function needs to set port forwarding, resulting in a complicated system.

### SUMMARY OF THE INVENTION

According to a first aspect of the present invention, there is provided with an access management apparatus which connects a communication network to a local area network and which manages access from the communication network to the local area network, the access management apparatus comprising: a packet receiver which receives a packet according to TCP or UDP from the communication network; a database storage unit which stores a database having a port number of the TCP or UDP in association with a MAC address; a MAC address detector which detects a MAC address associated with a destination port number in the packet received by the packet receiver, from the database; a start-up request packet generator which generates a start-up request packet to start up a terminal device having the detected MAC address on the local area network; and an output unit which outputs the generated start-up request packet to the local area network.

According to a second aspect of the present invention, there is provided with a program for inducing an access management device which connects a communication network to a local area network and which manages access from the communication network to the local area network, to execute: a packet receiving step which receives a packet according to TCP or UDP from the communication network; a MAC address detecting step which detects a MAC address associated with a destination port number in the received packet, from a database having a port number of the TCP or UDP in association with a MAC address; a start-up request packet generating step which generates a start-up request packet to start-up a terminal device having the detected MAC address on the local area network; and an outputting step which outputs the generated start-up request packet to the local area network.

According to a third aspect of the present invention, there is provided with a remote start-up method that is used in an access management device which connects a communication network to a local area network and which manages access from the communication network to the local area network, comprising: receiving a packet according to TCP or UDP from the communication network; detecting a MAC address associated with a destination port number in the received packet, from a database having a port number of the TCP or UDP in association with a MAC address; generating a start-up request packet to start-up a terminal device having the detected MAC address on the local area network; and outputting the generated start-up request packet to the local area network.

### BRIEF DESCRIPTION OF THE DRAWINGS

FIG. 1 is a diagram showing an illustrative example of a system being capable of performing a remote start-up method of a terminal device according to the present invention;

FIG. 2 is a block diagram schematically showing a configuration of a home router;

FIG. 3 is a diagram showing an example of a DHCP management table;

FIG. 4 is a diagram showing an example of an expanded NAT management table;

FIG. 5 is a block diagram showing a configuration example of a portion of a terminal device concerning automatic start-up; and

FIG. 6 is a flow chart showing an operation example of a home router.

### DETAILED DESCRIPTION OF THE INVENTION

Hereafter, embodiments of the present invention will be described with reference to the drawings.

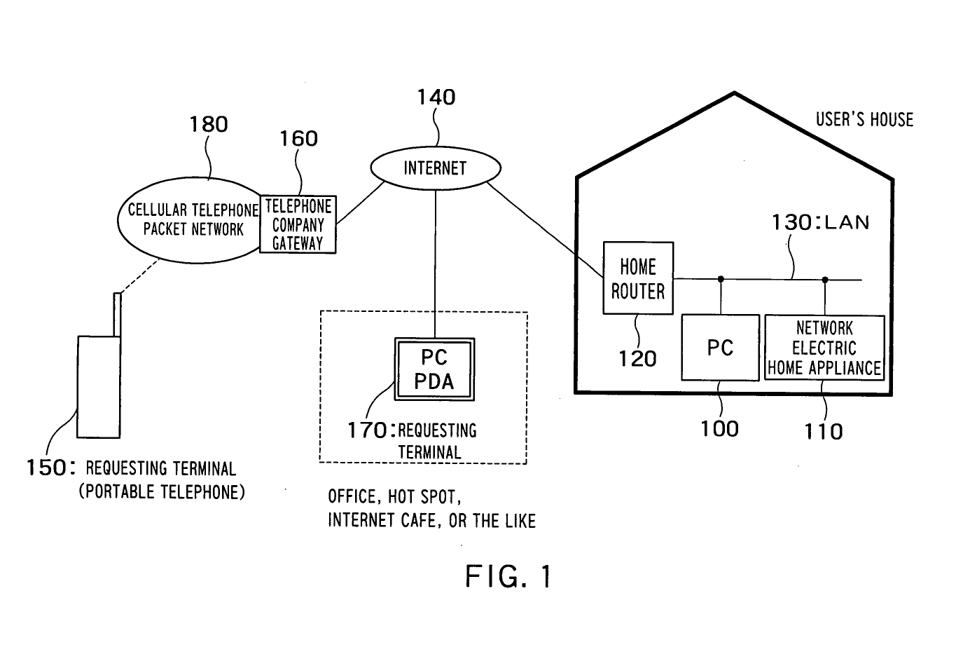

FIG. 1 is a diagram showing an illustrative example of a system being capable of performing a remote start-up method of a terminal device according to the present invention.

A requesting terminal 150, such as a cellular phone, carried by a user can be connected to Internet 140 serving as a communication network via a cellular phone packet network 180 and a gateway 160 of a telephone company that manages a cellular phone packet network.

A requesting terminal 170, such as a personal computer or a PDA, disposed in a company, a hot spot (a street corner Internet), an Internet cafe or the like can be connected to the Internet 140 directly or via an ISP (Internet Service Provider).

In a user's house, a home router 120 is installed to connect the Internet 140 and a LAN 130 disposed in the user's house to each other. The home router 120 is adapted to communicate with terminal devices 100 and 110 such as a personal computer or a network electric home appliance via the LAN 130.

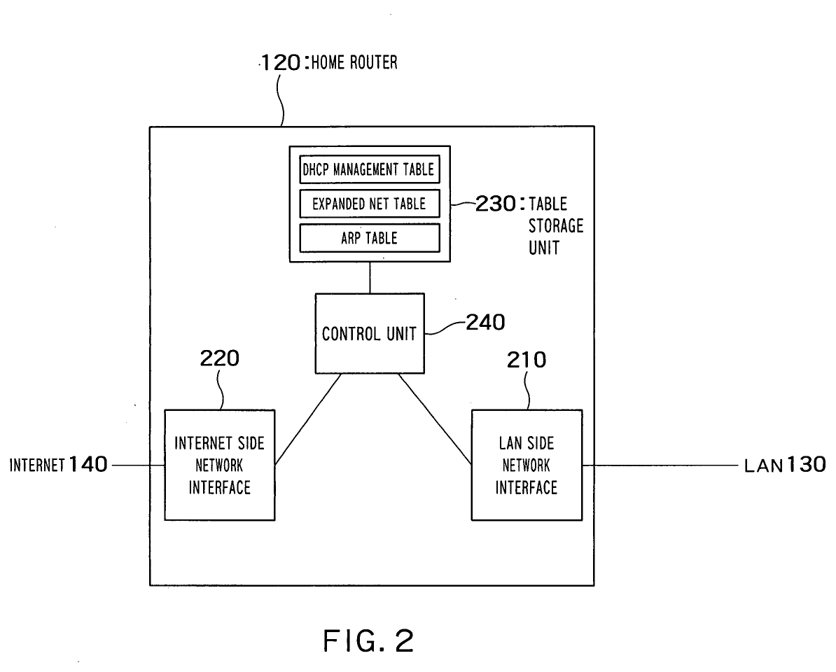

FIG. 2 is a block diagram schematically showing a configuration of the home router 120.

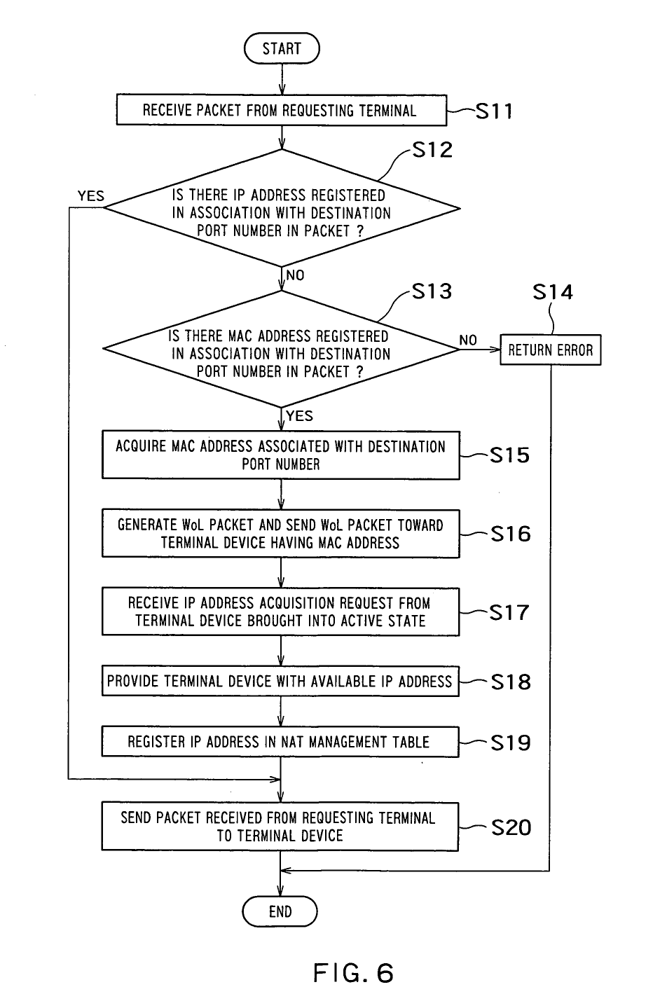

The home router 120 includes a LAN side network interface 210 for connection to the LAN 130, and an Internet side network interface 220 for connection to the Internet 140. A table storage unit 230 stores a DHCP management table, an expanded NAT table, and an ARP table. A control unit 240 conducts packet transfer processing, setting of the DHCP management table and the expanded NAT table, and various kinds of processing described later (including a process shown in FIG. 6).

In the Internet side network interface 220, the home router 120 is always connected to the Internet 140 via, for example, an ADSL line or an optical fiber line. The home router 120 had a global IP address used in the Internet 140. The global IP address may be a fixed IP address previously assigned by the ISP or the like, or may be a dynamic IP address provided by the ISP or the like according to the DHCP or PPPOE each time connection to the Internet 140 is conducted. The requesting terminals 150 and 170 can acquire an IP address of the home router 120 on the basis of a name of the home router 120 by using the DNS if the IP address is a fixed IP address and using the dynamic DNS if the IP address is a dynamic IP address.

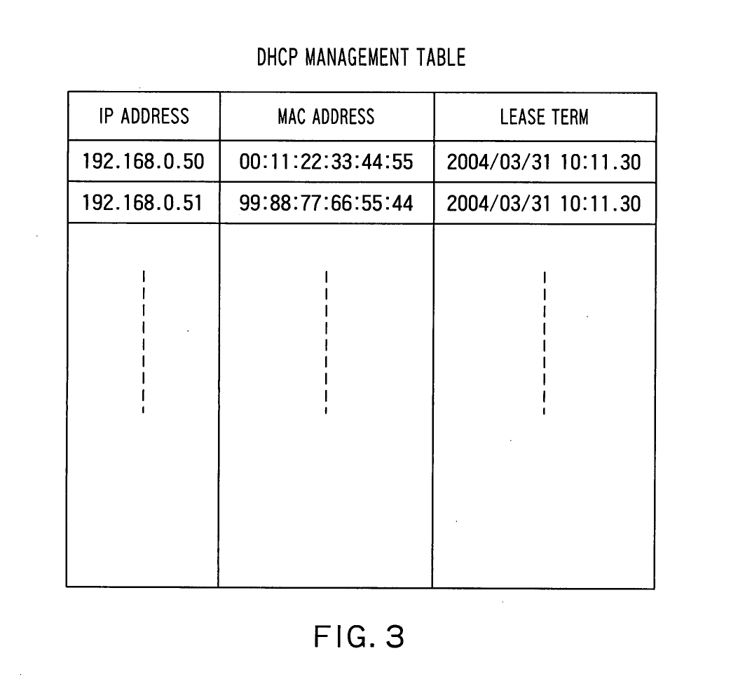

The control unit 240 in the home router 120 has a function of serving as a DCHP server. In other words, the home router 120 provides a terminal device connected to the LAN 130 with service as the DHCP server. In providing this service, the home router 120 uses the DHCP management table shown in FIG. 3. The DHCP management table manages association of the IP address with the MAC address. In addition, the DHCP management table also manages a lease term (validity term) of the IP address assigned to the terminal device. Since an operation procedure of the DHCP is well known, its detailed description will be omitted.

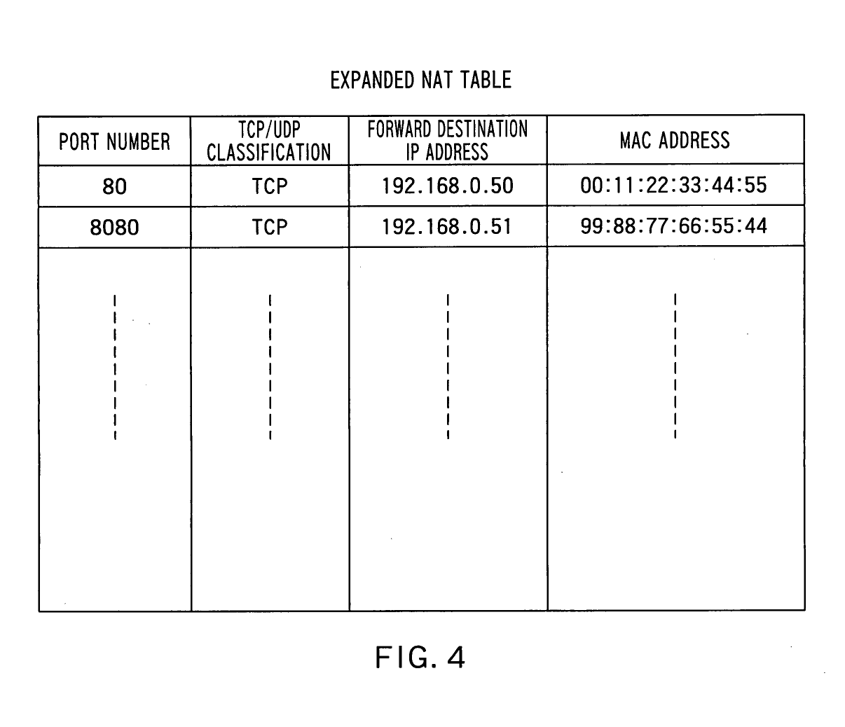

In addition, the control unit 240 in the home router 120 also has a function of serving as a UPnP-IGD (Internet Gateway Device). Owing to this function, the home router 120 can set IP port forwarding on the basis of a message according to the UPnP-IGD protocol sent from the terminal device 100 or the terminal device 110. More particularly, upon receiving an IP port forwarding setting request according to the UPnP-IGD protocol from the terminal device 100 or 110, the home router 120 writes an IP address, a port number, and a classification of the TCP (Transmission Control Protocol) or the UDP (User Datagram Protocol) into the expanded NAT management table shown in FIG. 4. According to this IP port forwarding setting, the home router 120 can conduct IP port forwarding of a packet received from the Internet 140, for a specific terminal device on the basis of a destination port number of the packet. It should be observed that the IP port forwarding setting using the UPnP-IGD is an example, and another scheme as described later may be used.

The expanded NAT management table manages the port number and the MAC address so as to associate them with each other. Association of the port number with the MAC address is previously set by user input. The association of the port number with the MAC address may be set at time of the IP port forwarding setting conducted by the UPnP-IGD or the like. In other words, the home router 120 refers to the ARP table (information of association of the IP address with the MAC address) retained in the table storage unit 230, detects a MAC address associated with an IP address registered in the expanded NAT management, and adds the detected MAC address to the expanded NAT management table. As a result, the home router 120 manages association of the port number with the MAC address. Here, the MAC address is detected by using the ARP table. However, the MAC address may be detected by using the DHCP management table.

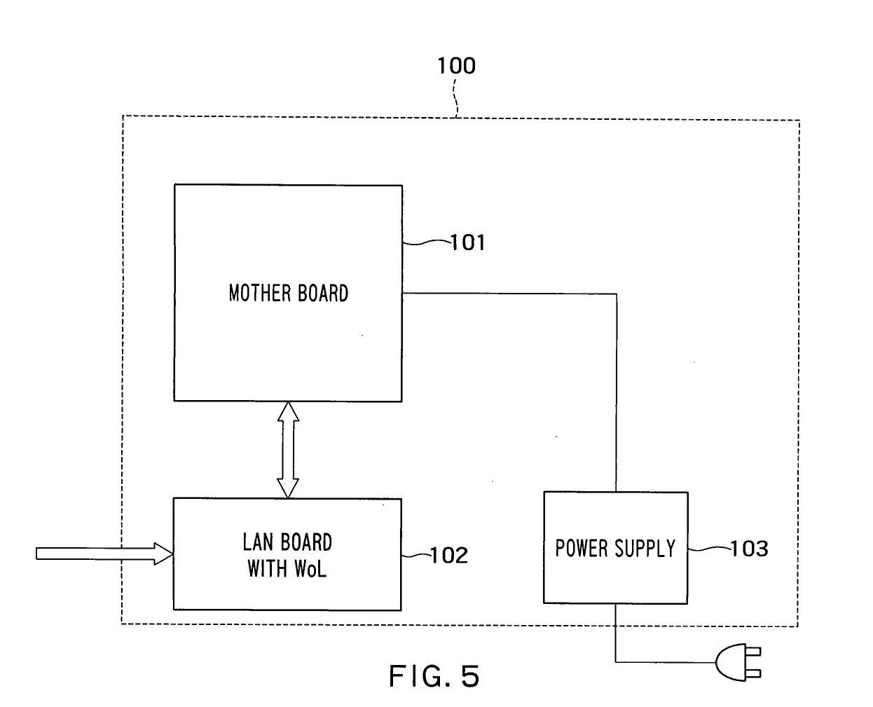

FIG. 5 is a block diagram showing a configuration example of a portion of the terminal device 100 concerning automatic start-up.

The terminal device 100 includes a LAN board 102 having a remote power throw-in (Wakeup on LAN which is hereafter referred to as WoL) function, and a motherboard 101 associated with the WoL function.

Upon receiving a Wake On signal (WakeOn packet) such as a magic packet (registered trade mark) from the LAN 130, the LAN board 102 outputs a Power On signal to the motherboard 101. Upon receiving the Power On signal, the mother board 101 outputs a power on signal to a power supply 103. As heretofore described, automatic power throw-in is implemented.

However, automatic power throw-in using a magic packet is an example, and another scheme may be used. Furthermore, the motherboard 101 may have the function of the LAN board including the WoL function.

Heretofore, the configuration of the portion concerning the automatic start-up of the terminal device 100 has been described. A portion concerning automatic start-up of the other terminal device 110 can be also made in the same way.

Hereafter, operation of the system shown in FIG. 1 will be described by taking the case where the requesting terminal 150 accesses the terminal device 100 in the user's house as one example.

FIG. 6 is a flow chart showing an operation example of the home router 120 in the present system.

First, the requesting terminal 150 transmits a packet including a certain destination port number toward the home router 120. As for the port number, for example, a number to be used is predetermined, or the port number is previously stored in the requesting terminal 150. It is possible that the user can set the port number for the terminal 100 or 110 in the requesting terminal 150 and in the case, the contents of the setting may be rendered to be reflected in the home router 120. A packet transmitted from the requesting terminal 150 is received by the home router 120 via the cellular phone packet network 180, the gateway 160, and the Internet 140 (step S11).

Upon receiving the packet, the home router 120 checks whether or not an IP address associated with the destination port number contained in the packet is registered in the expanded NAT management table (step S12).

In the case where the IP address is registered (YES at the step S12), the home router 120 transmits the packet to a target terminal device (step S20). At this time, the home router 120 rewrites a destination IP address and a destination port number in the packet by using a NAT function. The destination IP address obtained after the rewriting is an IP address registered in the expanded NAT management table. The destination port number obtained after the rewriting is previously set in the home router in association with the port number included in the expanded NAT table. Since the NAT function is well known technique, description of details thereof will be omitted.

In the case where the IP address is not registered (NO at the step S12), the home router 120 refers to the expanded NAT management table (see FIG. 4), and determines whether the destination port number contained in the packet is already registered in the expanded NAT management table. If the destination port number is already registered, the home router 120 determines whether a MAC address is registered for the destination port number, i.e., determines whether the MAC port forwarding has already been set (step S13). If the MAC port forwarding setting is not conducted yet (NO at the step S13), the home router 120 returns, for example, an error message to the requesting terminal 150 (step S14).

If the MAC port forwarding is set (YES at the step S13), the home router 120 gets a MAC address associated with the port number from the expanded NAT management table (step S15).

And the home router 120 generates a WoL packet to be sent to a device having the MAC address (here, the terminal device 100), and sends the generated WoL packet to the terminal device 100 (step S16). The home router 120 may detect an operational situation of the terminal device 100, and send the WoL packet only when the terminal device 100 is in standby situation. For example, the home router 120 may record final time of access to the port number, and if receiving time of the packet containing the port number is within a fixed time from the final access time, the home router 120 may regard the device as being in the active state and omit the sending of the WoL packet. Furthermore, when coming in the standby state, the device may throw a secession message “byebye” of the UPnP so as to make it possible for the home router 120 to grasp the state (the active state or the standby state) of the device and omit sending of WoL when the device is in the active state.

Upon receiving the WoL packet, the terminal device 100 comes in the active state (is automatically started up). The started up terminal device 100 sends a message (IP address acquisition request) according to the DHCP to the home router 120, and attempts to acquire an IP address.

Upon receiving an IP address acquisition request from the terminal device 100 (step S17), the home router 120 refers to the DHCP management table (see FIG. 3), specifies an available IP address, and provides the terminal device 100 with the specified IP address (step S18).

Upon providing the IP address, the home router 120 registers the IP address in the NAT management table (see FIG. 4) in association with a MAC address of the terminal device 100 (or the port number for the terminal device 100), and thereby sets the IP port forwarding (step S19). If a setting request of an IP port forwarding based on the UPnP-IGD is sent from a terminal device connected to the LAN 130, the home router 120 may set IP port forwarding in accordance with the request.

Upon setting the IP port forwarding, the home router 120 transmits the packet received from the requesting terminal 150 earlier, to the terminal device 100 (step S20). At this time, the home router 120 rewrites a destination IP address and a destination port number in the received packet by using a NAT function. The destination IP address obtained after the rewriting is an IP address registered in the expanded NAT management table. The destination port number obtained after the rewriting is previously set in the home router in association with the port number included in the expanded NAT table. Since the NAT function is well known technique, description of details thereof will be omitted.

The home router 120 that registered the IP address in the step S19, may check whether or not the terminal device 100 is present on the LAN 130, periodically by using the ICMP (Internet Control Message Protocol) or the like. The home router 120 may erase the IP address assigned to the terminal device 100 from the expanded NAT table in the case where the terminal device is not present on the LAN 130.

The home router 120 may erase the IP address assigned to the terminal device 100 from the expanded NAT table in the case where the lease term of the IP address (see FIG. 3) has expired.

The home router 120 may erase the IP address assigned to the terminal device 100 from the expanded NAT table in the case of receiving the secession massage from the terminal device 100.

While an example of access to the terminal device 100 has been described heretofore, access to the terminal device 110 can be also conducted in the same way. Furthermore, while an example of access from the requesting terminal 150 has been described heretofore, access from the requesting terminal 170 can be also conducted in the same way.

Furthermore, the home router 120 may permit access only from a requesting terminal having a specific IP address, and reject access from a requesting terminal having other IP address.

Upon detecting port scan from the Internet 140, the home router 120 may specify a transmission source IP address of the home scan as an IP address for which access is rejected.

The function of the home router 120 may be implemented by using a program, or may be implemented by using hardware. The program may be hold in a data carrier.

According to the present embodiment, a table that associates the destination port number with the MAC address is prepared in the home router as heretofore described. If a packet containing a destination port number is received, the home router sends a WoL packet to a terminal device having a MAC address associated with the destination port number. Therefore, the terminal device to be accessed can be automatically started up without adding a new function to the requesting terminal.

Furthermore, according to the present embodiment, the port number is associated with the MAC address in the home router. When the home router provides a terminal device with an IP address, it becomes possible to set IP port forwarding to the terminal device. In other words, even if a terminal device in a house acquires an IP address dynamically according to the DHCP, it becomes possible to conduct automatic setting of IP port forwarding in the home router without using the function such as UPnP-IGD.

What is claimed is:

1. An access management apparatus which connects a communication network to a local area network and which manages access from the communication network to the local area network, the access management apparatus comprising:
a packet receiver which receives a packet according to TCP or UDP from the communication network;
a database storage unit which stores a database having a port number of the TCP or UDP in association with a MAC address;
a MAC address detector which detects a MAC address associated with a destination port number in the packet received by the packet receiver, from the database;
a start-up request packet generator which generates a start-up request packet to start up a terminal device having the detected MAC address on the local area network; and
an output unit which outputs the generated start-up request packet to the local area network.

2. The access management apparatus according to claim 1, further comprising:
an IP address manager which manages a plurality of IP addresses which are able to be assigned;
an assignment request receiver which receives IP address assignment request for requesting assignment of the IP address;
an IP address assigner which assigns the IP address to the terminal device in a case where the assignment request receiver has received the IP address assignment request from the terminal device; and
an IP address sender which sends a packet having the assigned IP address toward the terminal device in order to provide the terminal device with the assigned IP address.

3. The access management apparatus according to claim 2, further comprising:
a packet generator which generates a packet obtained by setting the assigned IP address to a destination IP address field of the packet received by the packet receiver; and
a packet output unit which outputs the generated packet to the local area network.

4. The access management apparatus according to claim 2, further comprising
a register which registers the assigned IP address in the database in association with the MAC address of the terminal device.

5. The access management apparatus according to claim 4, further comprising:
a checker which checks whether or not the terminal device is present on the local area network; and
an entry eraser which erases the IP address assigned to the terminal device from the database, in a case where the terminal device is not present.

6. The access management apparatus according to claim 4, further comprising
an entry eraser which erases the IP address assigned to the terminal device from the database, in a case where a validity term of the IP address assigned to the terminal device has expired.

7. The access management apparatus according to claim 4, further comprising
an entry eraser which erases the IP address assigned to the terminal device from the database, in a case of receiving a secession massage from the terminal device.

8. The access management apparatus according to claim 4, further comprising:
a further packet generator, in a case where a further packet is received by the packet receiver, which detects a destination port number in the further packet, which detects an IP address associated with the destination port number from the database, and which generates a packet obtained by setting the detected IP address to a destination IP address field of the further packet; and
a further packet output unit which outputs this generated packet to the local area network.

9. The access management apparatus according to claim 1, wherein the start-up request packet generator generates a magic packet as the start-up request packet.

10. The access management apparatus according to claim 1, further comprising a detector which detects an operational status of the terminal device, wherein
the output unit outputs the start-up request packet in a case where the terminal device is in standby status.

11. A program for inducing an access management device which connects a communication network to a local area network and which manages access from the communication network to the local area network, to execute:
a packet receiving step which receives a packet according to TCP or UDP from the communication network;
a MAC address detecting step which detects a MAC address associated with a destination port number in the received packet, from a database having a port number of the TCP or UDP in association with a MAC address;
a start-up request packet generating step which generates a start-up request packet to start-up a terminal device having the detected MAC address on the local area network; and
an outputting step which outputs the generated start-up request packet to the local area network.

12. The program according to claim 11, further for inducing the device to execute:
an assignment request receiving step which receives IP address assignment request for requesting assignment of an IP address;
an IP address assigning step which assigns an IP address to the terminal device in a case of receiving the IP address assignment request from the terminal device; and
an IP address sending step which sends a packet having the assigned IP address toward the terminal device, in order to provide the terminal device with the assigned IP address.

13. The program according to claim 12, further for inducing the device to execute:
a packet generating step which generates a packet obtained by setting the assigned IP address to a destination IP address field of the packet received by the packet receiving step; and
a packet outputting step which outputs the generated packet to the local area network.

14. The program according to claim 12, further for inducing the device to execute a registering step which registers the assigned IP address in the database in association with the MAC address of the terminal device.

15. The program according to claim 14, further for inducing the device to execute:
a detecting step, in a case where a further packet is received from the communication network, which detects a destination port number in the further packet;
a further detecting step which detects an IP address associated with the destination port number from the database;
a further packet generating step which generates a packet obtained by setting the detected IP address to a destination IP address field of the further packet; and
a further packet outputting step which outputs this generated packet to the local area network.

16. A remote start-up method that is used in an access management device which connects a communication network to a local area network and which manages access from the communication network to the local area network, comprising:
receiving a packet according to TCP or UDP from the communication network;
detecting a MAC address associated with a destination port number in the received packet, from a database having a port number of the TCP or UDP in association with a MAC address;
generating a start-up request packet to start-up a terminal device having the detected MAC address on the local area network; and
outputting the generated start-up request packet to the local area network.

17. The method according to claim 16, further comprising:
receiving IP address assignment request for requesting assignment of an IP address;
assigning an IP address to the terminal device in a case of receiving the IP address assignment request from the terminal device; and
sending a packet having the assigned IP address toward the terminal device, in order to provide the terminal device with the assigned IP address.

18. The method according to claim 17, further comprising:
generating a packet obtained by setting the assigned IP address to a destination IP address field of the received packet; and
outputting the generated packet to the local area network.

19. The method according to claim 17, further comprising
registering the assigned IP address in the database in association with the MAC address of the terminal device.

20. The method according to claim 19, further comprising:
in a case where a further packet is received from the communication network, detecting a destination port number in the further packet;
detecting an IP address associated with the destination port number from the database;
generating a packet obtained by setting the detected IP address to a destination IP address field of the further packet; and
outputting this generated packet to the local area network.
